(19) United States
(12) Patent Application Publication
(10) Pub. No.: US 2022/0321051 A1
(43) Pub. Date: Oct. 6, 2022

(54) A Combined Sea Wave Photovoltaic Power Plant

(71) Applicant: ECO WAVE POWER LTD, Tel Aviv (IL)

(72) Inventor: Inna Braverman, Akko (IL)

(73) Assignee: ECO WAVE POWER LTD, Tel Aviv (IL)

(21) Appl. No.: 17/638,214

(22) PCT Filed: Sep. 11, 2019
(86) PCT No.: PCT/IL2019/051015

§ 371 Date: Feb. 25, 2022

(30) Foreign Application Priority Data
Aug. 27, 2019 (IL) 268942

(51) Int. Cl. H02S 10/10; H02J 3/38; B63B 35/44; B63B 35/34; F03B 13/14

(52) U.S. Cl. CPC H02S 10/10; H02J 3/381; B63B 35/44; B63B 35/34; F03B 13/14; H02J 2300/24; B63B 2035/4453; B63B 2035/4466; F05B 2220/708; F05B 2240/93

(57) ABSTRACT

A combined sea wave photovoltaic power plant for generating electricity from sea waves and from the sun that includes a pontoon, a jib, a hydro-cylinder, a photovoltaic panel, and conversion system that is designed to be connected to the electricity grid. The photovoltaic panel is assembled on a top of the pontoon and is connected to the conversion systems.

### TECHNICAL FIELD

The present invention refers to a combined sea wave photovoltaic power plant.

### BACKGROUND ART

Sea wave power plants (100) for production electricity from sea wave energy are common and known worldwide. The sea wave power plant (100) includes conversion system (300) that may include converters (301), inverters (302), electronic boards (303), automation systems (304), connection systems (305) to the electricity grid (400), and other kinds of equipment and systems that are designed to transform and to efficiently transfer the electricity from the generator into the electricity grid. The sea wave power plants (100) are also include pontoons (306), jibs (307) and hydro-cylinders (308), wherein one end of each jib is connected to a pontoon and a second end is connected to the hydro-cylinder as customary.

Photovoltaic power plants (200) that produce electricity from solar energy are also known and used worldwide. The photovoltaic power plants (200) includes photovoltaic panels (201) and some conversion systems (300), similar in general to the conversion systems of the sea wave power plants. With the time and commercialization of photovoltaic power plants, the prices of the parts have significantly decreased, but one main part which is still relatively expensive is the lease or use of land for the installation of the solar panels, which require at least 10 cubic meters for each 1 KW of installed capacity. Moreover, there is a negative impact to the construction of photovoltaic power plants because they contaminate the land on which it is installed, hence after the equipment is removed the land cannot be used for residential or agriculture for a long time, due to damage caused to it by the photovoltaic power plant.

The present invention discloses a combined sea wave photovoltaic power plant (500) which significantly reduces the costs of generating electricity from the photovoltaic panels (201) and eliminates the high costs required for the land space required for the installation and operation of the solar panels. In addition, it enables the production of electricity from 2 different and complimenting renewable energy sources on the same space (ocean space vs expensive land space). Moreover, the combination of both sources will enable to generate energy in a more stable manner, whereas the PV will generate more during the summer, when the waves are lower, and the floaters will generate electricity from the waves in the winter, when there is less sun and more waves and stormy weather.

### DESCRIPTION OF THE DRAWINGS

FIG. 1 schematically depicts the sea wave power plant (100).

FIG. 2 schematically depicts the photovoltaic power plant (200).

FIG. 3 schematically depicts the conversion system (300).

FIG. 4 schematically depicts the combined sea wave photovoltaic power plant (500).

FIG. 5 schematically depicts the photovoltaic panel (201) assembled on the top (3060) of the pontoon (306).

FIG. 6 depicts the pontoon (306), the jib (307) and the hydro cylinder (308).

### THE INVENTION

The main objective of the present invention is to provide a combined sea wave photovoltaic power plant (500) that includes at least one pontoon (306), at least one jib (307), at least one hydro-cylinder (308), at least one photovoltaic panel (201), and conversion system (300). The conversion system may include converters (301), inverters (302), electronic boards (303), automation systems (304), connection systems (305) to the electricity grid (400), and other kinds of equipment and systems that are designed to transform and to efficiently transfer the electricity from a generator or the photovoltaic panel to the electricity grid.

It is clearly understood that one end of the jib is connected to the pontoon and the second end is connected to the hydro-cylinder, for generating power from the sea waves. The photovoltaic panel (201) is assembled on the top (3060) of the pontoon (306) and is connected to the conversion systems (300).

A standard sized commercial-scale sea wave power plant may include about 300 pontoons or more (306) and provide a certain amount of electricity to the electricity grid (400). It is possible to implement the concept of the present invention to the surface of the floaters of such sea wave power plant and to convert it to a combined sea wave photovoltaic power plant by assembling 300 photovoltaic panels or more (201) on the tops (3060) of those 300 pontoons (306) and by that to increase the electricity production while decreasing the price and usage of land for the solar panels.

There are many advantages to the combined sea wave power plant-sea wave photovoltaic power plant (500).

First, the fact that energy can be generated from the photovoltaic panels (201) mounted on the pontoons (306) while using the existing conversion system (300) of the sea wave power plant significantly reduces the cost of producing energy from the sun by these photovoltaic panels. It is important to note that a significant expense in establishing a photovoltaic power plant is the land, the conversion system, and the basic construction (frames) on which the panels are assembled, in order to face the sun in a certain required degree. The investment in adding photovoltaic panels to a sea wave power plant and connecting them to the existing conversion system is relatively low.

Second, there is no need to allocate land for placing these photovoltaic panels, which means that on the same area it is possible to produce more electricity, both from the sun and from the waves. In addition, there is a negative impact to the construction of photovoltaic power plants because they contaminate the land on which it is installed, hence after the equipment is removed the land cannot be used for residential or agriculture for a long time, due to damage caused to it by the photovoltaic power plant. Once the solar panels are installed on the pontoons, such damage will be prevented, as no land will be used.

Third, the combined power plant can provide energy to the electricity grid more steadily and continuously, as when there are no waves, usually on sunny days, energy can be generated from the sun and supplied to the electricity grid, and when there is no sun (usually in the winter), energy can be supplied by the waves.

Fourth, in the combined working regime, there is no need for expensive constructions/frames for placing the photovoltaic panels and facing them in a certain degree towards the sun, due to the fact that the panels are placed on the pontoons that serve as a basic construction/frames. When the photovoltaic panels are mounted on the pontoons they are already at a compatible angle to generate energy from the sun, and in any case the proper angle can be controlled and adjusted by changing the angle of the pontoons.

Fifth, the installation of solar panels on top of pontoons which are partially sunk in the sea, will create higher efficiency in PV production. First, due to the fact that some of the energy from PV is lost due to heat. The water surrounding the panels when installed on the pontoons will have a cooling effect, thereby causing less loss of energy to heat energy. Second, when the sea and ocean state is calm, the water will have a mirroring effect, which will be cause the panels to produce higher amounts of electricity.

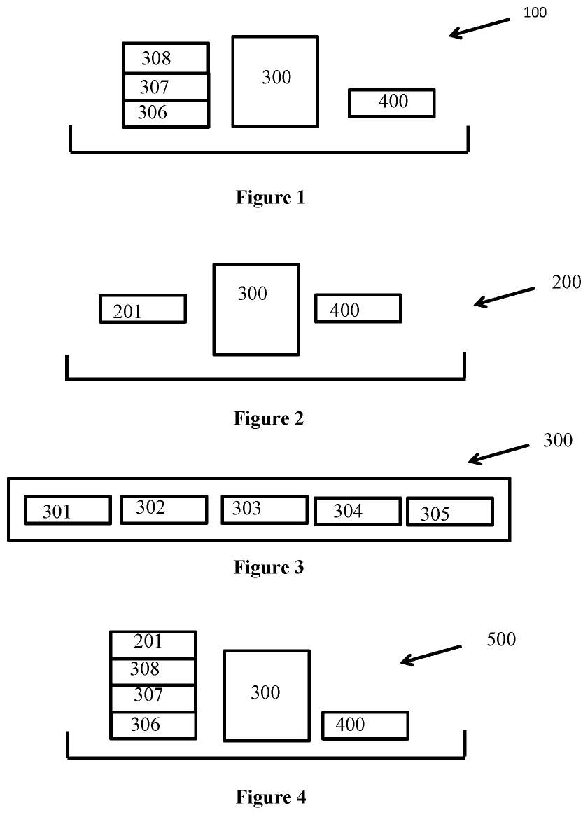

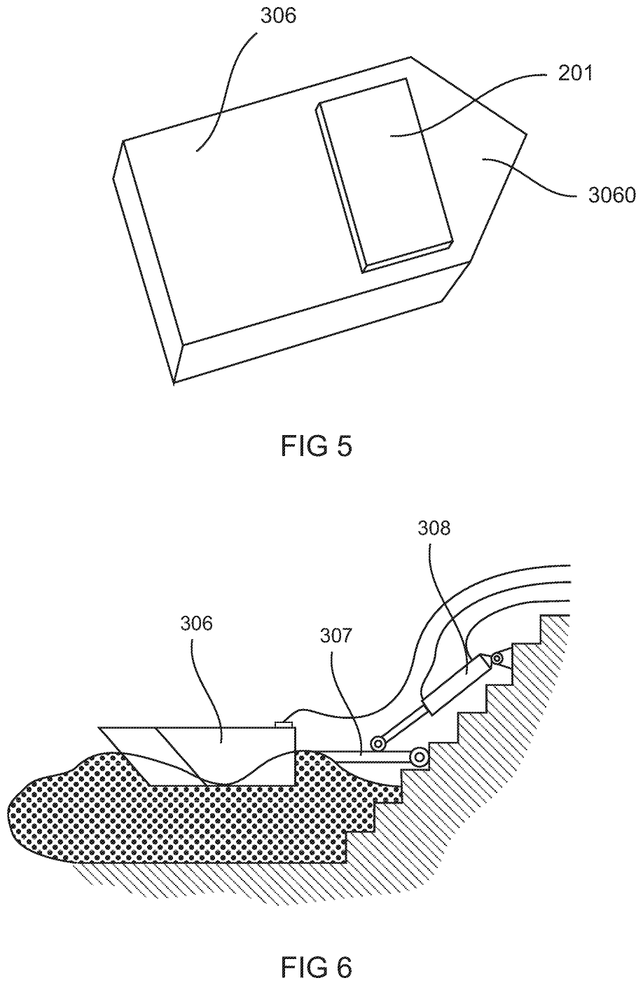

FIG. 1 schematically depicts the sea wave power plant (100), FIG. 2 schematically depicts the photovoltaic power plant (200), FIG. 3 schematically depicts the conversion system (300), FIG. 4 schematically depicts the combined sea wave photovoltaic power plant (500), FIG. 5 schematically depicts the photovoltaic panel (201) assembled on the top (3060) of the pontoon (306), and FIG. 6 depicts the pontoon (306), the jib (307) and the hydro cylinder (308).

What is claimed is:

1. A combined sea wave photovoltaic power plant for generating electricity from sea waves and from sun, comprising: at least one pontoon, at least one jib, at least one hydro-cylinder, at least one photovoltaic panel, and conversion system that is designed to be connected to electricity grid; wherein one end of the jib is connected to the pontoon and the second end is connected to the hydro-cylinder; wherein the photovoltaic panel is assembled on a top of the pontoon and is connected to the conversion systems.
